(19) United States
(12) Patent Application Publication
(10) Pub. No.: US 2006/0145054 A1
(43) Pub. Date: Jul. 6, 2006

(54) Electron multiplier

(76) Inventors: Hiroyuki Hanai, Shizuoka (JP); Suenori Kimura, Shizuoka (JP)

Correspondence Address: DRINKER BIDDLE & REATH (DC), 1500 K STREET, N.W., SUITE 1100, WASHINGTON, DC, 20005-1209, US

(21) Appl. No.: 10/561,035

(22) PCT Filed: Jun. 16, 2004
(86) PCT No.: PCT/JP04/08443

§ 371 Date: Dec. 16, 2005

(30) Foreign Application Priority Data
Jun. 17, 2003 (JP) 2003-172494

(51) Int. Cl. H01J 43/04

(52) U.S. Cl. 250/207

(57) ABSTRACT

A venetian blind dynode 5A of the first stage collects incident electrons efficiently, multiplies these electrons, and emits the multiplied secondary electrons to a metal channel dynode 5B of the second stage. By metal channel dynodes 5B of the second stage onward successively multiplying the incident secondary electrons efficiently, the secondary electrons, which are multiplied in multiple stages, are detected efficiently as an electrical signal. Since the layered state of metal channel dynodes 5B of the second stage onward can be made thin, the total length of the dynode unit in the layering direction can be made short and compact.

### TECHNICAL FIELD

This invention relates to an electron multiplier comprising a dynode unit, wherein a plurality of dynodes are positioned in a layered state in multiple stages.

### BACKGROUND ART

As a dynode unit of an electron multiplier, an arrangement, wherein a plurality of venetian blind dynodes are positioned in a layered state in multiple stages, has been generally known since priorly (see, for example, Patent Document 1). An arrangement, wherein a plurality of metal channel dynodes are positioned in a layered state in multiple stages, has also been generally known since priorly (see, for example, Patent Document 2).

Here, each venetian blind dynode has a plurality of louver-like electrode elements that are cut and raised at an angle of substantially 45 degrees from a substrate, with the respective electrode elements being adjacent each other and inclined in the same direction. On the outer surface of each electrode element is formed a secondary electron emitting surface, which multiplies incident electrons and then emits the multiplied electrons.

Meanwhile, with a metal channel dynode, a plurality of through holes, which are slit holes, aligned parallel to each other, or are circular holes or rectangular holes, aligned in matrix form, are opened in a substrate, and each through hole has an inner wall surface of inclined cross-sectional shape such that the opening width at an emitting side, from which electrons are emitted, is wider than the opening width at a collecting side, onto which electrons are made incident. On the inner wall surface of each through hole is formed a secondary electron emitting surface, which multiplies electrons made incident from the collecting side and emits the multiplied electrons.

Patent Document 1: Japanese Published Examined Patent Application No. 2840853

Patent Document 2: Japanese Published Examined Patent Application No. 3078905

### DISCLOSURE OF THE INVENTION

### PROBLEMS TO BE SOLVED BY THE INVENTION

With the above-mentioned venetian blind dynode, since the plurality of electrode elements are cut and raised in louver-like form, the thickness is large in comparison to the metal channel dynode. Thus when the number of stages of dynodes are the same, an electron multiplier, equipped with a dynode unit in which all stages are arranged from venetian blind dynodes, is considerably longer in total length than an electron multiplier, equipped with a dynode unit in which all stages are arranged from metal channel dynodes, and is disadvantageous as an electron multiplier with which the shortening of the total length is required.

This invention has been made in view that a venetian blind dynode can collect incident electrons efficiently and an object thereof is to provide an electron multiplier, with which the shortening of the total length and improvement of the detection efficiency can be achieved at the same time.

### MEANS FOR SOLVING THE PROBLEM

This invention's electron multiplier comprises a dynode unit, in which a plurality of dynodes are positioned in a layered state in multiple stages, and is characterized in that in the dynode unit, the dynode of the first stage is arranged as a venetian blind dynode and the dynodes of the second stage onward are arranged as metal channel dynodes.

With this invention's electron multiplier, the venetian blind dynode of the first stage collects incident electrons efficiently, multiplies these electrons, and emits the multiplied secondary electrons to the metal channel dynode of the second stage. By the metal channel dynodes of the second stage onward successively multiplying the incident secondary electrons efficiently, the multiplied secondary electrons are detected efficiently as an electrical signal.

This invention's electron multiplier may be provided with an auxiliary electrode that guides the secondary electrons, emitted by the venetian blind dynode of the first stage, toward the metal channel dynode of the second stage. In this case, since the auxiliary electrode guides the secondary electrons emitted by the venetian blind dynode of the first stage to the metal channel dynode of the second stage without waste, the detection efficiency of the electron multiplier is improved further.

### EFFECTS OF THE INVENTION

With this invention's electron multiplier, since incident electrons are collected efficiently and multiplied by the venetian blind dynode of the first stage and the multiplied secondary electrons are successively multiplied efficiently by the metal channel dynodes of the second stage onward, the detection efficiency is improved.

Also with this invention's electron multiplier, since the dynodes of the second stage onward of the dynode unit are arranged as metal channel dynodes, with which the layered state can be made thin, the total length in the layering direction of the dynode unit can be made short and compact.

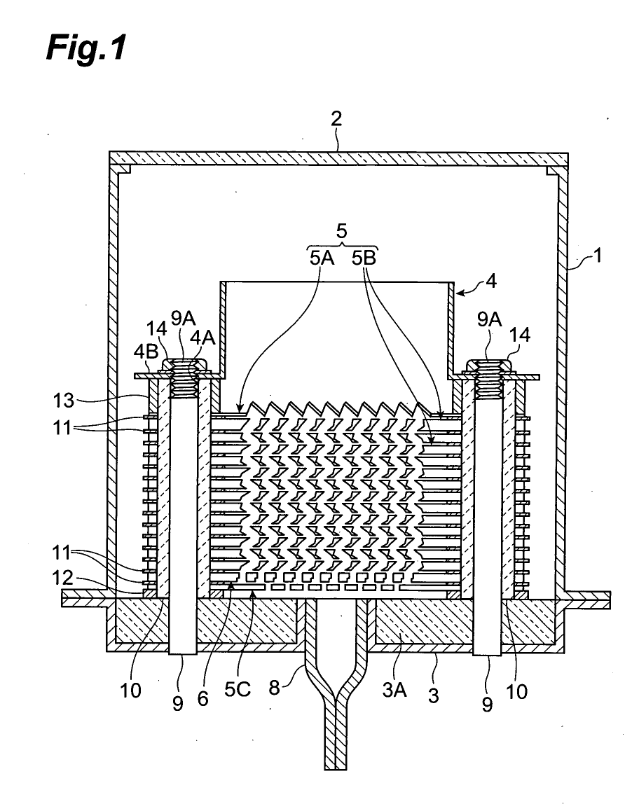

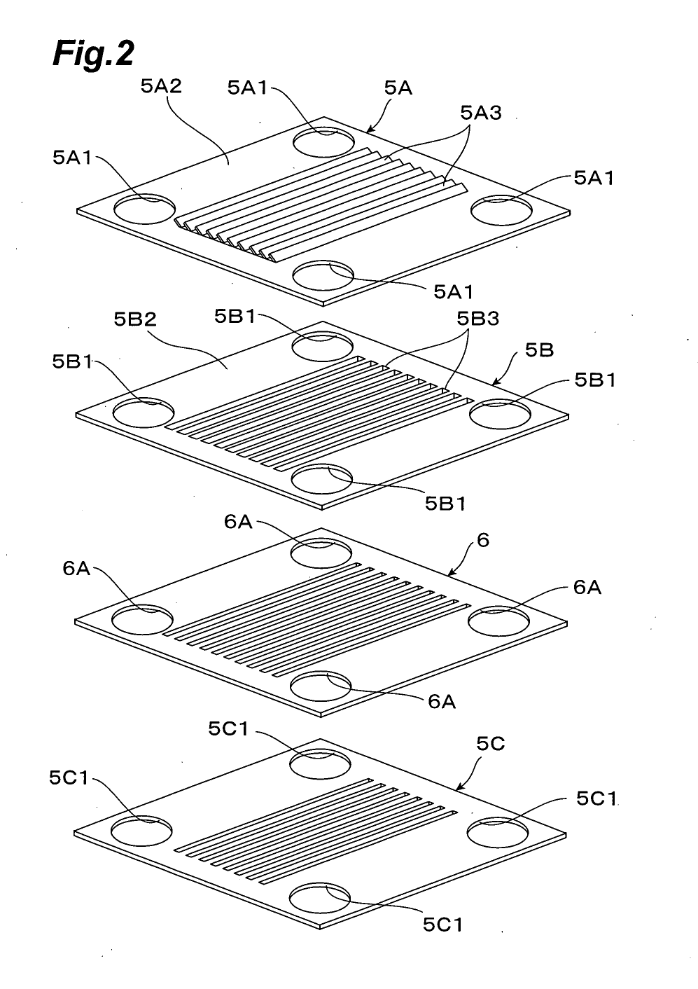

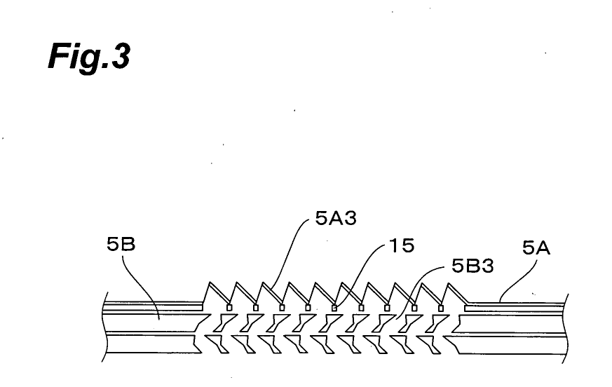

### BRIEF DESCRIPTION OF THE DRAWINGS

[FIG. 1] A longitudinal sectional view of the internal structure of an electron multiplier of an embodiment of this invention.

[FIG. 2] FIG. 2 is a perspective view of the principal components of the dynode unit shown in FIG. 1.

[FIG. 3] FIG. 3 is a perspective view of an auxiliary electrode interposed between a venetian blind dynode and a metal channel dynode of the dynode unit shown in FIG. 1.

### DESCRIPTION OF THE SYMBOLS

1 . . . side tube, 2 . . . light receiving surface plate, 3 . . . stem plate, 4 . . . focusing electrode, 5 . . . dynode unit, 5A . . . venetian blind dynode, 5B . . . metal channel dynode, 6 . . . anode, 7 . . . sealing ring, 8 . . . exhaust tube, 9 . . . column, 10 . . . insulating pipe, 11 . . . insulating spacer, 12 . . . insulating ring, 13 . . . insulating ring, 14 . . . nut, 15 . . . auxiliary electrode.

### BEST MODES FOR CARRYING OUT THE INVENTION

An embodiment of this invention's electron multiplier shall now be described with reference to the drawings. In regard to the referred drawings, FIG. 1 is a longitudinal sectional view of the internal structure of an electron multiplier of an embodiment, and FIG. 2 is a perspective view of the principal components of the dynode unit shown in FIG. 1.

As shown in FIG. 1, the electron multiplier of the embodiment is, for example, arranged as a head-on PMT (photomultiplier), wherein a focusing electrode 4, a dynode unit 5, an anode 6, etc., are housed inside a vacuum container of a structure, with which a light receiving surface plate 2 is fixed in an airtight manner onto an opening at one end of a cylindrical side tube 1 and a stem plate 3 is fixed in an airtight manner onto an opening at the other end.

Side tube 1 is arranged as a Kovar metal tube, having flanges formed at both ends, and the peripheral edge portion of light receiving surface plate 2 is thermally fused onto the flange at one end and a flange of stem plate 3 is joined by welding to the flange at the other end.

Light receiving surface plate 2 is formed of circular Kovar glass with a thickness, for example, of approximately 0.7 mm and a photoelectric surface (not shown) is formed on the inner surface of the portion that opposes a light incidence window.

The material of light receiving surface plate 2 may be changed as suited in accordance with the required light transmitting characteristics to synthetic quartz, UV glass, borosilicate glass, etc.

Stem plate 3 is formed of Kovar metal and the interior is formed to a dish-like form that is filled with an insulating sealing member 3A, formed of borosilicate glass. An unillustrated plurality of stem pins are passed through stem plate 3 in an airtight manner and connected to the respective dynodes of a dynode unit 5. An exhaust tube 8, for drawing vacuum from the interior of the vacuum container, is fitted and fixed in an airtight manner to a central portion of stem plate 3 and an outer end portion thereof is closed off.

For example, four columns 9, for firmly supporting focusing electrode 4, the dynodes of the respective stages of dynode unit 5, and anode 6, are erected on stem plate 3. Each column 9 is embedded in an airtight manner in insulating sealing member 3A with its base end portion passing through stem plate 3. An insulating pipe 10 is fitted onto each column 9.

Focusing electrode 4 is formed to a short, circular cylindrical (or rectangular cylindrical) form with a flange portion 4B, having formed therein mounting holes 4A into which the respective columns 9 are fitted, and is positioned at the inner side of side tube 1 with its opening directed toward light receiving plate 2.

Here, with dynode unit 5, the dynode of the first stage is arranged as a venetian blind dynode 5A, and the dynodes of the second stage onward, for example, to a fourteenth stage, are arranged as metal channel dynodes 5B.

As shown in FIG. 2, venetian blind dynode 5A has a plurality of louver-like electrode elements 5A3 that are cut and raised at an angle of substantially 45 degrees from a substrate 5A2, having mounting holes 5A1, into which the respective insulating pipes 10 (see FIG. 1) are fitted, formed at four corners. The respective electrode elements 5A3 are parallel and adjacent to each other and are inclined in the same direction, thereby exhibiting the appearance of blinds as a whole.

On the outer surface of each electrode element 5A3 that faces the light receiving surface plate 2 side is formed a secondary electron emitting surface, which receives electrons, emitted from the photoelectric surface of light receiving surface plate 2 and converged by focusing electrode 4, and emits secondary electrons resulting from multiplication of the received electrons.

With venetian blind dynode 5A of such a structure, since the secondary electron emitting surfaces of the respective electrode elements 5A3 are adjacent each other and secure a wide area as whole, the photoelectron collection efficiency is high and more secondary electrons can be emitted to metal channel dynode 5B of the second stage.

Each metal channel dynode 5B has a plurality of through holes 5B3, opened in slit-like form in a substrate 5B2, having mounting holes 5B 1, into which the respective insulating pipes 10 (see FIG. 1) are fitted, formed at four corners. The respective through holes 5B3 extend parallel to each other and in alignment with the respective electrode elements 5A3 of venetian blind dynode 5A.

Each through hole 5B3 has an inner wall surface of inclined cross-sectional shape such that the opening width at the emitting side is wider than the opening width at the secondary electron collecting side (see FIG. 1), and on the inner wall surface thereof is formed a secondary electron emitting surface, which multiplies the secondary electrons, made incident from the collecting side, and emits the multiplied electrons.

With metal channel dynode 5B with the above-described structure, since the opening widths of each through hole 5B3 are such that the opening width at the emission side is set wider than the opening width at the secondary electron collection side, the damping field that guides the secondary electrons to metal channel dynode 5B of the subsequent stage enter deeply from the emission side opening into the interior of through hole 5B3. Each metal channel dynode 5B can thus guide secondary electrons efficiently into metal channel dynode 5B of the subsequent stage.

Here, as shown in FIG. 1, venetian blind dynode 5A of the first stage and metal channel dynodes 5B of the second to fourteenth stages of dynode unit 5 are supported in multiple stages along with anode 6 and dynode 5C of the final stage in a mutually insulated, layered state.

As a structure for this arrangement, mounting holes 6A and mounting holes 5C1, into which the respective insulating pipes 10 (see FIG. 1) are fitted, are respectively formed in the four corners of anode 6 and dynode 5C of the final stage as shown in FIG. 2. Also, as shown in FIG. 1, a plurality of washer-like insulating spacers 11 and a plurality of insulating rings 12 and 13, which are fitted onto the respective pipes 10, are provided and a plurality of nuts 14, which are screwed onto male thread portions 9A formed on the tip portions of the respective columns 9, are provided.

By fitting insulating rings 12, mounting holes 5C1 of dynode 5C of the final stage, insulating spacers 11, mounting holes 6A of anode 6, and insulating spacers 11 in that order onto the respective insulating pipes 10, then fitting mounting holes 5B1 of metal channel dynodes 5B and insulating spacers 11 alternatingly onto the respective insulating pipes 10, and then fitting mounting holes 5A1 of venetian blind dynode 5A and insulating rings 13 onto the respective insulating pipes 10, venetian blind dynode 5A of the first stage and metal channel dynodes 5B of the second to fourteenth stages are positioned in multiple stages along with anode 6 and dynode 5C of the final stage in a mutually insulated, layered state.

Here, the tip portions of the respective columns 9 are fitted into the respective mounting holes 4A formed in flange portion 4B of focusing electrode 4, and by the respective nuts 14, screwed onto male thread portions 9A formed on the tip portions of the respective columns 9, pressing insulating rings 13 via flange portion 4B of focusing electrode 4, focusing electrode 4, venetian blind dynode 5A of the first stage, metal channel dynodes 5B of the second to fourteenth stages, anode 6, and dynode 5C of the final stage are supported integrally and firmly along with the respective insulating spacers 11 by the respective columns 9.

With the electron multiplier of the embodiment that is arranged as described above, when light to be measured is illuminated onto light receiving surface plate 2, the photoelectric surface on the rear side emits photoelectrons and the emitted photoelectrons are converged onto venetian blind dynode 5A of the first stage by the actions of focusing electrode 4.

Here, with venetian blind dynode 5A of the first stage, since the secondary electron emitting surfaces of the respective electrode elements 5A3 are adjacent each other and secure a wide area as a whole, the photoelectrons, converged by focusing electrode 4, are collected efficiently and multiplied and the multiplied secondary electrons are emitted toward metal channel dynode 5B of the second stage.

With metal channel dynodes 5B of the second to fourteenth stages, since the opening widths of each through hole 5B3 are such that the opening width at the emission side is set wider than the opening width at the secondary electron collection side, the collection efficiency of secondary electrons, which are collected by metal channel dynode 5B of a subsequent stage from metal channel dynode 5B of a prior stage, is high. As a result, the secondary electrons that are collected efficiently and multiplied by venetian blind dynode 5A of the first stage are successively multiplied efficiently by metal channel dynodes 5B of the second to fourteenth stages.

The secondary electrons that are thus multiplied efficiently are detected efficiently as an electrical signal by means of anode 6.

Whereas with an electron multiplier, with which even the dynode of the first stage is a metal channel dynode 5B, the detection efficiency of light to be measured was 66%, with the electron multiplier of the embodiment, with which the dynode of the first stage is venetian blind dynode 5A, the detection efficiency of light to be measured rose to 74%.

Here, with the electron multiplier of the embodiment, since the dynodes of the second to fourteenth stages of dynode unit 5 are arranged from metal channel dynodes 5B, with which the layered state can be made thin, the total length in the direction of layering of dynode unit 5 can be made short and compact.

Thus by the electron multiplier of the embodiment, improvement of the detection efficiency of light to be measured and shortening of the total length can be achieved at the same time.

With the electron multiplier of the embodiment, since venetian blind dynode 5A, the respective metal channel dynodes 5B, and the respective insulating spacers 11, which make up dynode unit 5, are integrally and firmly supported, along with anode 6 and dynode 5C of the final stage, by columns 9, these will not undergo inadvertent lateral deviation due to vibration or impact and dynode unit 5 exhibits excellent anti-vibration performance.

This invention's electron multiplier is not restricted to the embodiment. For example, each of metal channel dynodes 5B that make up the dynodes of the second stage onward of dynode unit 5 may have a plurality of circular or rectangular through holes positioned in matrix form instead of the slit-like through holes.

Also, as shown in FIG. 3, a slit-like auxiliary electrode 15, which guides the secondary electrons emitted by venetian blind dynode 5A of the first stage to metal channel dynode 5B of the second stage, may be disposed between venetian blind dynode 5A of the first stage and metal channel dynode 5B of the second stage. In this case, since the secondary electrons emitted by venetian blind dynode 5A of the first stage are guided without waste by auxiliary electrode 15 to metal channel dynode 5B of the second stage, the detection efficiency of light to be measured is improved further.

Furthermore, this invention's electron multiplier may be an electron multiplier that does not have a photoelectric surface.

### INDUSTRIAL APPLICABILITY

With this invention, since the venetian blind dynode of the first stage efficiently collects and multiplies incident electrons and the multiplied secondary electrons are successively multiplied efficiently by the metal channel dynodes of the second stage onward, an electron multiplier of improved detection efficiency can be provided.

1. An electron multiplier comprising a dynode unit, in which a plurality of dynodes are positioned in a layered state in multiple stages, wherein in the dynode unit, the dynode of the first stage is arranged as a venetian blind dynode and the dynodes of the second stage onward are arranged as metal channel dynodes.

2. The electron multiplier according to claim 1, further comprising an auxiliary electrode that guides the secondary electrons, emitted by the venetian blind dynode of the first stage, toward the metal channel dynode of the second stage.
